(19) United States
(12) Patent Application Publication
(10) Pub. No.: US 2007/0237395 A1
(43) Pub. Date: Oct. 11, 2007

(54) CAD VIRTUAL AREA LOCATOR

(75) Inventors: Herman Spencer JR., Las Vegas, NV (US); Phillipe Cantin, Henderson, NV (US)

Correspondence Address: VIERRA MAGEN MARCUS & DENIRO LLP, 575 MARKET STREET SUITE 2500, SAN FRANCISCO, CA, 94105, US

(73) Assignee: TRIRIGA LLC, Las Vegas, NV (US)

(21) Appl. No.: 11/691,368

(22) Filed: Mar. 26, 2007

Related U.S. Application Data
(63) Continuation of application No. 10/629,401, filed on Jul. 28, 2003.
(60) Provisional application No. 60/398,924, filed on Jul. 26, 2002.

(51) Int. Cl. G06K 9/46

(52) U.S. Cl. 382/203

(57) ABSTRACT

An automated system for generating an analysis of a CAD drawing and annotating the drawing. In one embodiment, the invention is an application for a computer comprising a virtual area locater for a computer drawing. In another aspect, the invention is a method for marking a computer aided design drawing using a processing device. The method includes the steps of: finding at least one reference vector in the drawing; determining an area definition based on drawing data relative to said reference vector; and marking said drawing to indicate a area definition. The step of finding a reference vector may include defining a door gap.

### CLAIM OF PRIORITY

The present application is a continuation application of U.S. patent application Ser. No. 10/629,401, titled “CAD VIRTULA AREA LOCATOR,” filed on Jul. 28, 2003, which claims priority from U.S. Provisional Patent Application No. 60/398,924, entitled “CAD VIRTUAL AREA LOCATOR”, filed Jul. 26, 2002; both applications are incorporated herein by reference in their entirety.

### BACKGROUND OF THE INVENTION

1. Field of the Invention

The present invention is directed to the marking and annotation of CAD drawings and using such annotations in a useful manner.

2. Description of the Related Art

The construction of a large project, such as a building, typically involves many phases. The design phase usually starts with one or more design professionals creating initial design drawings (e.g., prints) of the final project according to a developer's direction. The prints generally include perimeter lines representing specific areas (e.g., restaurants, rooms, lobbies, offices, etc.) within the project. The prints may also include graphical representations of components within the specified areas. For example, an architect may create prints of a restaurant area of a Hotel/Casino project. The restaurant prints may include graphical representations of furniture, fixtures, mechanical equipment, electrical equipment, etc. Examples include tables, windows, ovens, refrigerators, a backup power generator, etc. The project may start with many different sets of prints, all related to each other.

Engineers and designers normally employ software applications for generating specification sheets for project components for which they have responsibility. Typical of these applications are computer aided design (CAD) applications which allow users to draw plans with exacting specificity.

The most popular commercial CAD programs on the market today are AUTOCAD® by AutoDesk Inc. and MicroStation by Bentley Corporation.

FIG. 1 depicts a two dimensional view of an office floor plan. Generally, such floor plan drawings are subdivided into rooms and particular elements of the plan, such as walls, features and furniture are depicted in the drawing. CAD applications include means to organize elements into groupings. One common technique used in AUTOCAD® and other programs, for example, is the concept of layers. Layers allow users to group, select and modify elements having commonalities by arranging such elements on specific and separate layers.

Normally, to organize drawings into sub-sections, manual marking is required. For example, CAD applications allow users to draw polygonal representations using demarcation lines to group elements in particular rooms together or to arrange the rooms in an organized fashion in the drawings.

Other applications and services, such as those depicted in co-pending patent applications entitled: BUSINESS ASSET MANAGEMENT SYSTEM, U.S. patent application Ser. No. 10/020,552 filed Oct. 30, 2001 (co-pending PCT Patent Application Serial No. PCT/US01/47965); ITEM SPECIFICATION OBJECT MANAGEMENT SYSTEM, U.S patent application Ser. No. 10/015,903 filed Oct. 30, 2001; BUSINESS ASSET MANAGEMENT SYSTEM USING VIRTUAL AREAS, U.S patent application Ser. No. 10/016,615 filed Oct. 30, 2001; INTELLIGENT OBJECT BUILDER, U.S patent application Ser. No. 10/021,661 filed Oct. 30, 2001 (co-pending PCT Patent Application Serial No. PCT/US01/48449); and INTEGRATED BUSINESS SYSTEM FOR THE DESIGN, EXECUTION, AND MANAGEMENT OF PROJECTS, U.S patent application Ser. No. 09/519,935 filed Mar. 7, 2000, all depict a comprehensive design and build system which enables users to connect intelligent data to drawings, elements of the drawings, or specific “virtual areas” of the drawings, and share such intelligent data with other authorized users of the systems. The concept of a “virtual area” is discussed in above-referenced application Ser. No. 10/016,615. Poly-lines can be used to mark and denote such virtual areas.

Currently, there is no automated mechanism which allows users to quickly and easily mark and annotate areas within a CAD drawing such as that shown in FIG. 1. Specifically, were one desirous of marking the particular offices with poly-lines and sub-dividing such areas, no mechanism other than the human mind—and manual labor—is currently available.

### SUMMARY OF THE INVENTION

The present invention, roughly described, pertains to an automated system for generating a comprehensive analysis of a CAD drawing and annotating the drawing. In particular, the system can discern between wall lines and doors in a depiction of a building floor plan and provide a polygonal depiction of each room. In a further aspect, the system can use the polygonal representations to provide a hierarchical representation of the internal structure of a building.

In one embodiment, the invention is an application for a computer comprising a virtual area locater for a computer drawing.

In one aspect, the invention is a method for marking a computer aided design drawing using a processing device. The method includes the steps of: finding at least one reference vector in the drawing; determining an area definition based on drawing data relative to said reference vector; and marking said drawing to indicate a area definition.

In yet another aspect, the step of finding a reference vector comprises defining a door gap. In a further aspect, the step of determining an area definition comprises defining a virtual area definition. In yet another aspect, the step of finding includes the step of creating at least one temporary memory structure representing the drawing data.

In another aspect, the step of marking comprises creating CAD polyline entities in said drawing data

In another embodiment, the invention is a method for marking a computer aided design drawing using a processing device. In this embodiment, the invention comprises the steps of finding a door gap in the drawing; determining a room relative to said door; and marking said drawing to indicate a room definition.

In another embodiment, the method for automatically marking a computer aided design drawing using a processing device includes the steps of retrieving at least a set of door lines and a set of wall lines from the drawing; creating a set of gap lines defining at least one door gap; and determining a room area relative to each gap line.

In a still further embodiment, the invention comprises one or more processor readable storage devices having processor readable code embodied on said processor readable storage devices, said processor readable code for programming one or more processors to perform a method. In this aspect, the method includes the steps of finding a door gap in the drawing; determining a room relative to said door; and marking said drawing to indicate a room definition.

Still further, the invention may comprise a drawing analysis application operable on a processing device comprising code for instructing a processor to perform the steps of: creating at least one temporary data structure storing drawing information; determining from the temporary data structure door gaps in the drawing; successively determining walls of a room relative to the door gap; and creating a room definition based on said step of successively determining.

In another embodiment, the invention is a system for marking a drawing, comprising: a processing device; non-volatile memory coupled to the processing device instructing the processing device to perform the steps of: finding at least one reference vector in the drawing; determining an area definition based on drawing data relative to said reference; and marking said drawing to indicate a area definition.

More generally, the invention is a system for marking a drawing which may be integrated with a CAD application to enable automated annotation of drawings of building floor plans. By implementing the system, doors, walls and rooms are analyzed and used to define poly-line. This information may then be used for a variety of purposes, but is particularly suited to the creation of virtual areas used in conjunction with the system described above in co-pending U.S. patent application Ser. Nos. 10/020,552 and 10/016,615. This automation process allows for the automation of a previously time-consuming, manual marking process.

The present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

The invention will be described with respect to the particular embodiments thereof. Other objects, features, and advantages of the invention will become apparent with reference to the specification and drawings in which:

FIG. 1 depicts a CAD drawing of an office suite or building.

FIG. 2A is a block diagram depicting a number of clients running various forms of software coupled to a network and a database.

FIG. 2B is a block diagram of a general purpose computer which may comprise the client or server depicted in FIG. 2A.

FIG. 3 is a flowchart of a setup process for implementing the area locator system of the present invention.

FIG. 4 is a flowchart of the area locator algorithm used in accordance with the present invention.

FIGS. 5A-5C are depictions of memory representation of a set of lines and points of a drawing used in the present invention.

FIG. 6A is a depiction of a door element.

FIGS. 6B-6D are depictions of gap lines derived by and used by the system of the present invention.

FIGS. 7A and 7B are depictions of how the system of the present invention determines gap lines.

FIG. 8 is a depiction of a process of “walking the room” to locate a polygonal area.

FIG. 9 is a depiction of the result of the removal of a door recess.

FIG. 10 is a depiction of the result of the elimination of redundant points.

FIG. 11 is a flowchart depicting a setup process of implementing the room organizer function of the system.

FIG. 12 is a flowchart depicting the room organization algorithm used in accordance with the present invention.

FIG. 13 is a depiction of rooms organized into virtual areas and groups in a hierarchical fashion.

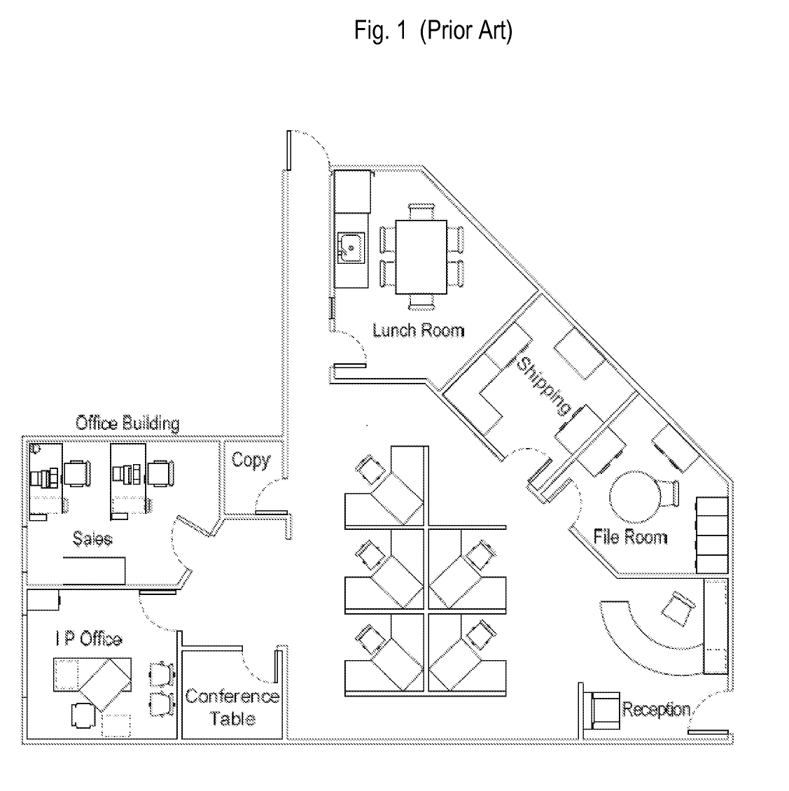

### DETAILED DESCRIPTION

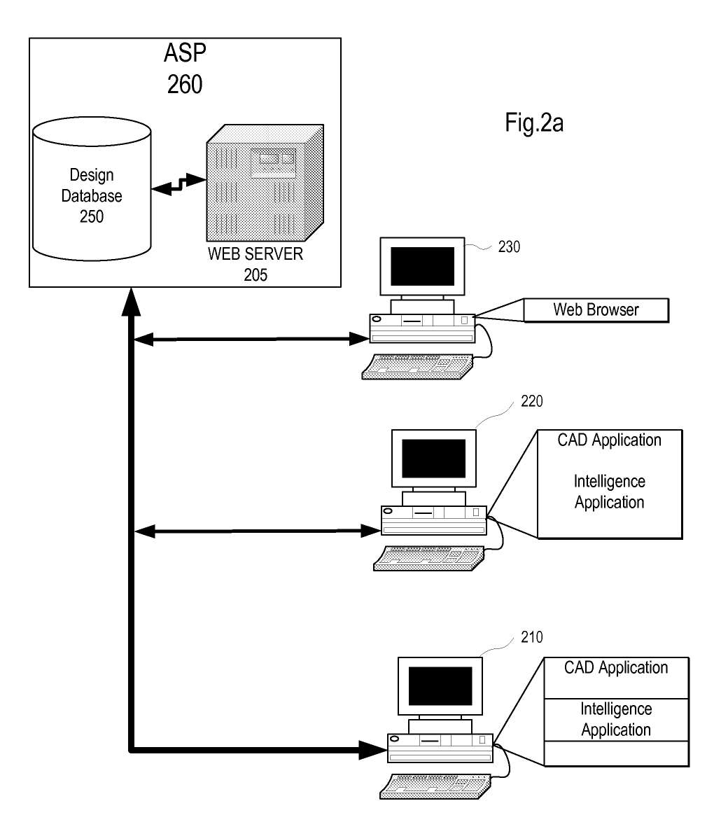

FIG. 2A is a depiction of how the system of the present invention may be implemented.

In order to allow the finder system of the present invention to determine elements of a drawing, in one embodiment, the system comprises a series of algorithms that operate on or in conjunction with a CAD system. A CAD system may include hardware or software and is used to create precision drawings or technical illustrations. CAD software can be used to create two-dimensional (2-D) drawings or three-dimensional (3-D) models.

FIG. 2A illustrates client computers coupled to a network, and via the network to a design database such as that described in the above-cited co-pending applications. An ASP may maintain the design database and provide additional services such as the design and management tools described in the co-pending applications. These may include a web-server which provides additional services to users, including tools to access user data stored in the database through a browser-based application.

Computer 210 is a general purpose computer having installed thereon a CAD application and an intelligence application which allows the CAD application to communicate with the design database or the ASP system. For example, the intelligence application may function to allow elements and specifications such as those described in the co-pending applications to be downloaded to and manipulated in the database. One example of an intelligence application is described in co-pending application INTELLIGENT OBJECT BUILDER, U.S patent application Ser. No. 10/021,661 filed Oct. 30, 2001 (co-pending PCT Patent Application Serial No. PCT/US01/48449).

In conjunction with computer 210, the intelligence application may include the algorithms discussed below, or may call such algorithms from the ASP as needed. The intelligence application as represented in conjunction with computer 210 is a plug-in application for the CAD system which integrates itself and is provided by the ASP. In this context, the application may be downloaded by the user from the ASP Web Server and installed on computer 210, with the methods programmatically implemented in any of a number of existing technologies, such as Java. Computer 220 shows the intelligence application integrated by and provided with the CAD software itself such that no separate integration or installation is required. In this instance, all executables and/or libraries required to implement the methods described herein are included with the CAD application.

FIG. 2B shows one example of a hardware architecture for computers used to implement the present invention. The hardware includes a processor 202, a memory 204, a mass storage device 206, a portable storage device 208, a network interface 212 and I/O devices 214. The choice of processor is not critical as long as a suitable processor with sufficient speed is chosen. Memory 204 can be any conventional computer memory. Mass storage device 206 can include a hard drive, CD-ROM or any other mass storage device. Portable storage 208 can include a floppy disk drive or other portable storage device. The computer may include one or more network interfaces. The network interface can include a network card for connecting to an Ethernet or other type of LAN. In addition, one or more of the network interfaces can include or be connected to a firewall. One of the network interfaces will typically be connected to the Internet or a LAN. I/O devices 214 can include one or more of the following: keyboard, mouse, monitor, display, printer etc. Software used to perform the methods of the present invention are likely to be stored in mass storage 206 (or any form of non-volatile memory), a portable storage media (e.g. floppy disk or tape) and/or, at some point, in memory 204. Various embodiments, versions, and modification of the system of FIG. 2B can be used to implement a the present invention, and the above described hardware architecture is just one suitable example depicted in a generalized and simplified form. The present invention could include dedicated hardware, a firmware to implement the invention or other software and/or hardware architectures that are suitable.

It should be understood that the following algorithms need not be used in conjunction with the database of FIG. 2A, but could be used to mark drawings without ever communicating with the design database or ASP described above. In such cases, for example, the drawing may be stored on the non volatile memory of the computer running the algorithms. When used in conjunction with the design database, the ASP may provide other tools, as described in co-pending application Ser. No. 10/020,552 to allow users on computers such as 230, running only a web browser, to view and manipulate the information provided by the intelligence application to the database.

In addition, it should be understood that the following algorithms may be implemented in computer readable code to enable their application within a CAD Application, as a stand alone supplement to a CAD application, as a server side process operable from within an application such as a Web browser, or any other of a number of suitable means for implementing the processes described herein on drawing data.

As noted above, the finder application is particularly useful in providing “virtual areas”. A virtual area is a spatial representation of an asset (such as a building) that may contain components and items that can be used throughout the lifecycle of the asset. In one aspect, the virtual area is a concept for organizing and representing physical space as a hierarchical structure. It may refer to the physical breakdown of a property or designed object. Virtual Areas are used throughout the system of co-pending patent application Ser. No. 10/020,552 to organize a project and assign security permissions, specification counts, budgeting, and other functions.

Hence, the following description will refer to the polygonal depictions as “virtual areas”. However, it will be understood that such areas may be used for other purposes.

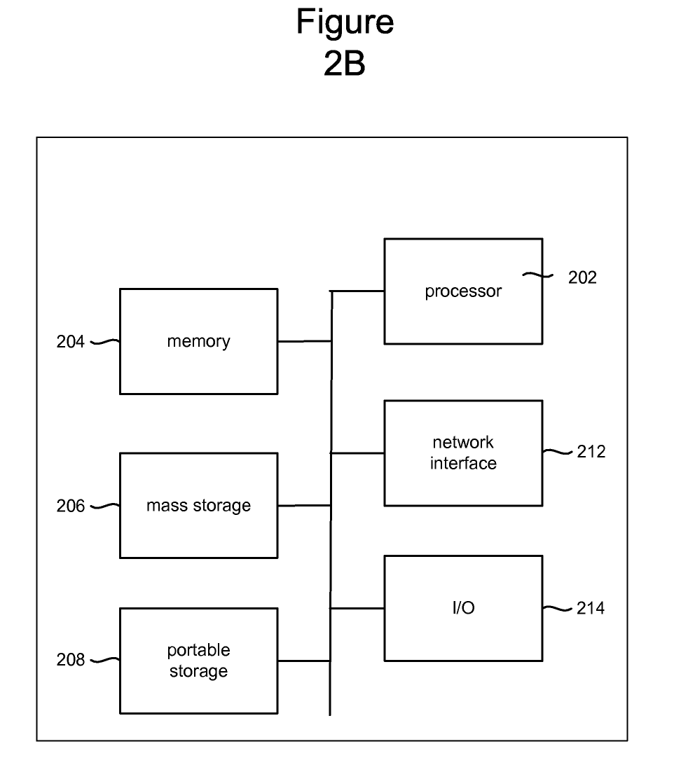

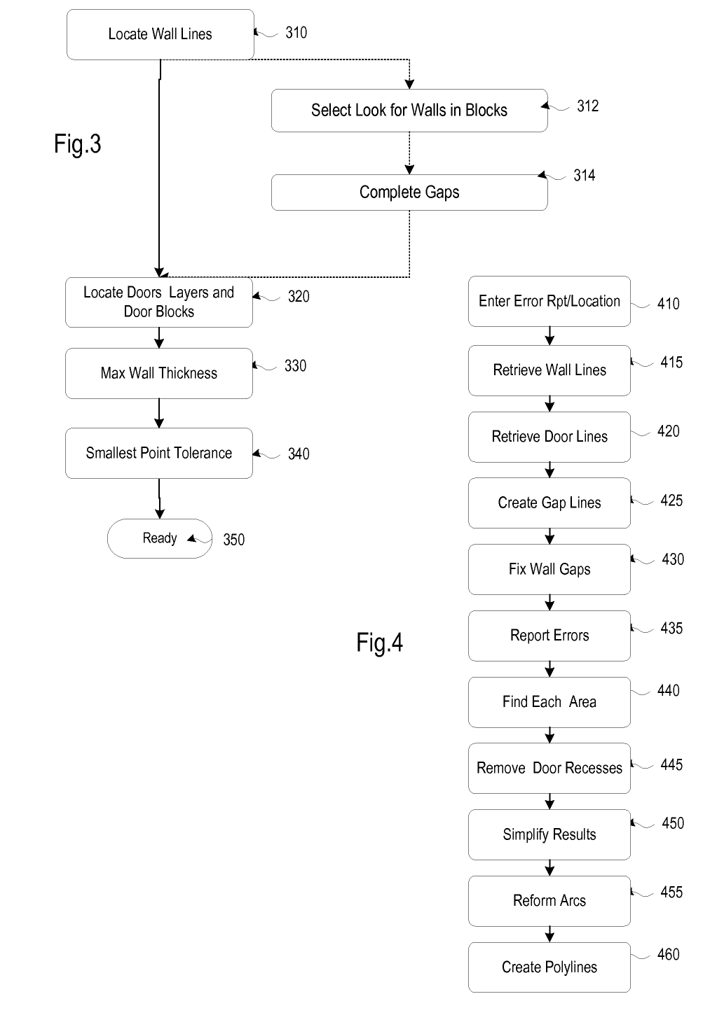

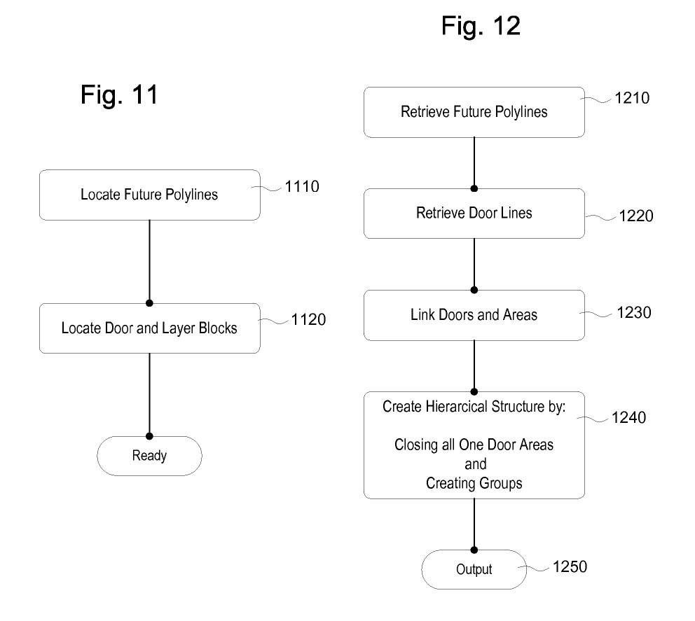

The components of the invention shown in FIGS. 3, 4, 11 and 12 comprise a Virtual Area Automatic Finder system. The program is a two component system composed of the ‘Automatic Room Finder’ (FIGS. 3 and 4) and the ‘Parent-Child Relationship Finder’ (FIGS. 11 and 12).

FIGS. 3 and 4 show the process of determining poly-lines. A poly-line is a line in a CAD drawing composed of multiple vertices and may sometimes contain arcs. In general, the program will make a comparative analysis between Wall Lines and Doors in the drawing and then find the inside contour poly-line (Virtual Area) of each room. Before implementing the process, certain data needs to be accessible and specified to the process.

This data and setup process is illustrated in FIG. 3.

Initially a user must locate Wall Lines in the drawing at step 310. A wall line is any line representing a wall or part of a wall. This can be done by specifying layers and or selecting layers. Wall lines can be any of the following entities: Line, Arc, Circle, LWPolyline, 2Dpolyline, 3Dpolyline (by dropping the Z values). In addition, the system can read 3D from the Autodesk architectural CAD package Architectural Desktop 3.3 (ADT 3.3, including: AecDbCurtainWallLayout, AecDbCurtainWallUnit, AecDbWindowAssembly, AecsDbMember, AecDbMassElem, AecMassGroup, AecDbDoor, AecDbWindow, AecDbOpening, AecDbRailing, AecDbSlab, AecDbSpaceBoundary, AecDbStair and AecDbWall. Any blocks found on a wall layer will be open and all the sub-entities will be interpreted as possible wall lines.

In order for a user to specify layers, a user interface is provided. The user interface may comprise a graphical user interface (GUI) which may be separate from, or incorporated into, the user interface of a CAD application. In one embodiment, the GUI comprises a menu item with a series of menu selections, one or more of which call the functions described herein. Selection of a menu item to implement the function may in turn provide a “pop-up” dialog box which provides drop-down menu selections, data entry fields and/or check boxes used to select optional steps outlined below. In the context of locating wall lines in a drawing, the GUI allows users to add to the selection by picking the entities by clicking the components of the drawing on a screen with a mouse, or selecting the names from a drop down list which is known to the system after the user specifies information on the layers or file locations of the drawing.

Wall lines should be placed alone on separate ‘Wall Layers’ to ensure that the finder component does not interpret other entities as possible walls. If other entities are interpreted as walls, an undesirable result may occur. Again, this allows easy organization of the drawing and the system described herein to conveniently find walls on such layers.

Following step 310, at step 312, a user may optionally select an option for the system to look for walls inside all Blocks. Some blocks, which are not on a wall layer, may contain sub entities on a wall layer. Graphically, one can add these sub-entities to the walls selection process, by selecting the ‘Look for walls inside all Blocks’ check box on a menu item used to input the initial settings.

A second optional step is to allow the system to complete gaps in walls. In a 2D drawing, not all the walls end with a ‘wall cap’. This creates a gap, preventing the creation of a possible Virtual Area. If the distance between the two wall ends is smaller than a maximum ‘Wall Thickness’ value, described below, the program can close that gap. To do this, a user may select the ‘Complete gaps in walls’ check box to call the functions of the program that perform this task in the context of the selection method.

Next, at step 320, a user must Locate Door Layers & Door Blocks. The doors can be selected in two different ways: by their block names and/or by layers. In the GUI you can add to the selection by picking the entities or select the names from a drop down list.

Next, at step 330, the user must determine the thickest wall and provide a maximum thickness value to the system. This value is used later to set the ‘Wall Thickness’ calculation variable. This variable is used to remove door recesses and fix wall gaps, as described below. In one instance, the ‘Wall Thickness’ should not be larger than or equal to half of a normal door gap. If this is the case, where, for example, some walls in the drawing are abnormally thick (exp: 2 feet thick) and others have a normal thickness (for example, 8 inches), a user can separate the two sets of walls on different layers and run the find algorithm for each set.

Finally, at step 340, a user must provide the smallest point tolerance. The point tolerance is a value used to determine which lines in a drawing should be connected, even where they might not actually be connected. For example, in many 2D drawings not all lines connect perfectly. One must specify a tolerance big enough to compensate for normal drawing errors. This value is used to set the ‘Point Tolerance’ calculation variable. If the value is too big, one may get strange results from the system output in that lines that are not supposed to be connected will appear to the system to be connected. In essence, the goal is to find the smallest tolerance possible. If a small quantity of lines and door blocks are clearly not touching, it is better to fix the drawing, and then call the Auto Find method with a smaller ‘Point Tolerance’ that is sufficient for the rest of the drawing, than it is to provide a large point tolerance.

Once the aforementioned set-up process is complete, the finding process illustrated in FIG. 4 may be used.

The finder algorithm illustrated in FIG. 4 was designed to work with data from any vector graphic format, and is especially effective in AutoDesk DWG and Bentley DGN formats. The finder algorithm of FIG. 4 may be used alone or in conjunction with the relationship finder of FIG. 12.

Initially, the user may select to generate an error report at step 410. This provides a report of all inconsistencies that the system finds and allows the user to make drawing changes to allow the system of the present invention to operate more efficiently. In doing so, the user may specify the layer name for the Error Report and for the new virtual areas. Finally the user can select to find all the Vas in the drawing or only the ones the user selects (by clicking inside them).

At step 415, all the Wall Lines in the drawing are retrieved and stored in memory as a collection of line elements and point elements. This memory structure is called Simple Mesh Structure (SMS) and is a temporary memory structure used for the duration of the method and then destroyed. In one aspect, the SMS is stored as a collection of points and lines that are a representation of the wall structure that is programmatically easier to understand. Essentially, it is a long list of points and lines, each line having at least two points and each point being capable of being attached to more than one line. The SMS is created in a manner that follows the following principles: No lines are crossing each other, No points are overlapping, Only one line can exist between two points, and a point must be attached to at least one line. The SMS is only a temporary memory representation of the drawing which is built, for example, with C++ Object Classes. These objects are destroyed when the finding process ends.

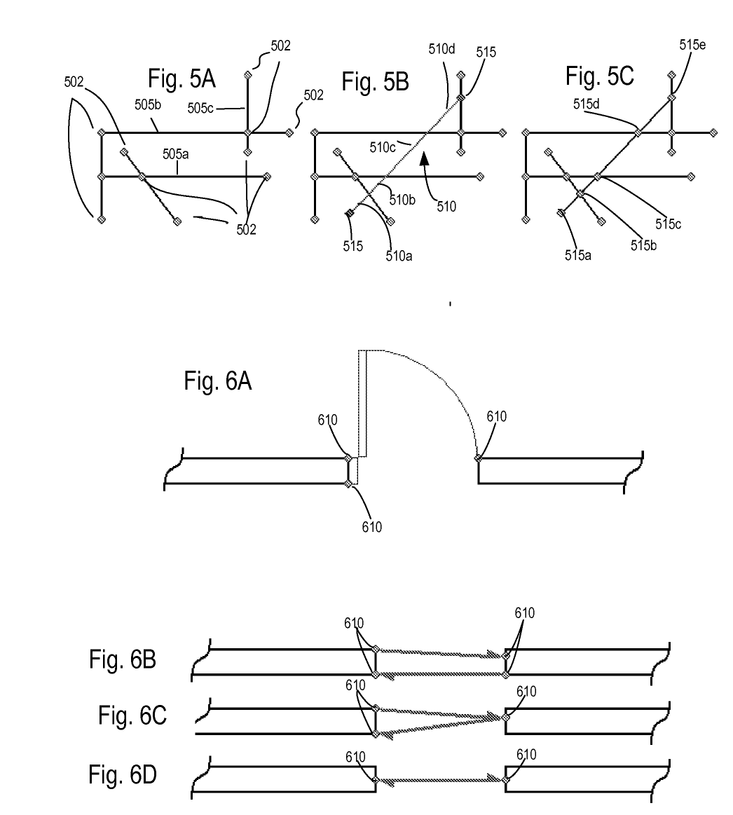

This structure is illustrated graphically in FIGS. 5A, 5B and 5C. FIG. 5A is a mesh comprising 11 points 502 and ten lines 505. There are two situations where the SMS may be altered: where an line is applied (but not added) to the SMS and where a line is added to the SMS. When a line is added to the mesh, it may affect the existing mesh and/or be affected by the existing mesh. The new line 510 is being cut by 3 of the mesh lines 505a-505c, creating 4 new segments 510a-510d and 5 new points 515a-515e. Also the new line is cutting 4 existing mesh lines 510a-510d. The resulting mesh shown in 5C is now composed of 16 points and 18 lines. There are generally two situations where one may want to modify a mesh: one needs to modify the mesh and NOT add the line (such as where the line is used for computational purposes only) or one wants to modify the mesh and ADD the new line (such as where simplification of an area is occurring, as described below). Lines are added to the mesh during a mesh building process, as the mesh is built “line-by-line”. Modifications to an SMS may occur, for example, when door lines are applied to a wall-line SMS (as described below) to modify the mesh without changing the mesh.

This SMS structure supports arcs (curved lines) as individual, dissected, two-point lines. When adding an arc to an SMS, a Curve Definition Object (CDO) is first created. A CDO defines an arc Center point, Radius and Direction (Clockwise or Counter Clockwise). Then the arc is stroked, based on the point tolerance, into multiple lines to which the CDO is attached. The point tolerance defines the length of the stroked lines. Then each line is separately added to the SMS. The CDO will be used later to rebuild any segment of that original arc. The CDO is a memory object that is linked (attached) to the lines element of the SMS. As for any elements used in the SMS, CDOs are destroyed at the end of the ‘finding’ process.

After the wall lines are retrieved and stored, the door lines are all retrieved and stored at step 420. The Door Lines are all stored together in a separate SMS (not the Wall Lines SMS). A door finder algorithm (described bellow) will find each isolated group of lines in that SMS and create a Door Group for each one. A Door Group is an isolated group of Door Lines connected together. A door line is any line representing a door or part of a door. To find a Door Group, the program starts with one line and gets all its connected lines recursively until all the sub-connected lines are gathered. Every time a line is included, it's marked as a “UsedLine” and cannot be part of another Door Group. We repeat this process for each unused line until each line is used.

Next, at step 425, Gap Lines are created. Gap lines are lines created by the system to close a door gap. A door gap is the width of a door opening. Using these elements, it is now possible to find the relation between the Door Groups and the Wall Lines. All contact points between a Door Group and the Wall Lines are found with an intersection algorithm.

FIG. 6A illustrates the contact points between a door group and wall lines. In any given drawing, a door group may have three contact points 610 as illustrated in FIG. 6A, or may have as few as two contact points or a large number of contact points. These points must be determined to find gap lines in the walls, which are in turn used to define the virtual areas.

FIGS. 6B-6D illustrate three types of gap lines formed by the system in the calculation of virtual areas. FIG. 6B illustrates a double gap line, made with four or more points, FIG. 6C a double gap line made with three points and FIG. 6D a single gap line made with two points.

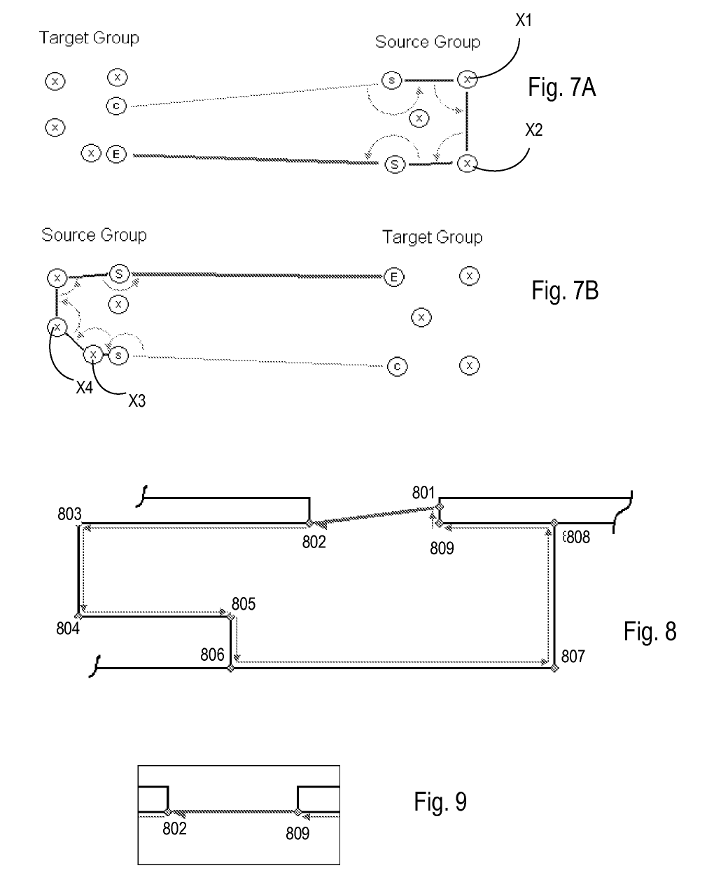

Those contact points are then organized in two sub-groups, one for each side of the door. (This is generally illustrated in FIGS. 7A and 7B with respect to the Source and Target groups.) This is using the WallThickness variable set by the user in the GUI. Two points are part of the same sub-group if the distance between them is smaller than two times the WallThickness variable.

Gap Line direction is used to determine the inside of a room, and must be determined for each line. If you are inside of a room, facing a Gap Line, the line always starts at your right and ends at your left. If only one Gap Line closes a door gap, it is then bidirectional and will be used to find the virtual areas for the two rooms.

The scenarios with Gap Lines of a type shown in FIGS. 6C or 6D are easy to solve. If there is only one point in each sub-group, it's a single bi-directional Gap Line of the type in FIG. 6D. If one of the two sub-groups contains only one point, we have a Gap Line of the type of FIG. 6C.

If there are two or more points in each group, a crossing line method, illustrated with respect to FIGS. 7A and 7B is used to find the two Gap Lines. This method follows the outside edge of the group of points until it reaches an edge that crosses between the two sub-groups. Before calling the function we have to find the two reference points needed by the function.

In the target group, a first point (any point) is selected. In this case, the point “c” is selected. Next, one determines the left-most point in the source group (where the source is to the right of the target group), in this case point “s”, and a line is determined between them. This line is considered an “edge line”. Point “s” is an edge point by definition. Next, the algorithm seeks to find the next line to a point with biggest angular distance relative to the edge line. In this case, this next line is the line from “s” to “x1”. X1 is now considered an edge point. Then the system will determine the next edge point with reference to the s-x1 line, which will be the line from x1-x2. These steps are repeated until an edge point is found which is not in the source group, in this case, point “S”. This occurs when the length of the line compared to the previous edge line is larger than the maximum wall thickness. The line formed by the last edge point from the source group and the edge point found in the target group is considered as a gap line.

The gap line is determined with a direction, and has a start and end which is used in the interior of the room. Note that the “c” point can be ANY point in the Target Group and the “s” point has to be the left most point in the Source Group, if one is standing at point “c” looking at the Source Group.

The process is then repeated by swapping the Target Group with the Source Group. One uses the previous “S” point as the new “c” point, and the previous “E” point as the new “s” point.

Once the gap lines are determined, wall gaps must be fixed at step 430. This fix is only performed on Error Points that are connected to one line only. If the distance between two Error Points is smaller or equal to the WallThickness tolerance, a line connecting the two points is created and both points marked with Cyan Circles on the Error Layer. The circles will help the user, by identifying the attempted fixes or needed fixes.

Next, errors are reported at step 435. All remaining Error Points are considered Irresolvable Errors and may be marked with, for example, Red Circles on the Error Layer. This will help the user, by identifying the critical errors.

Next, at step 440, each of the Virtual Areas are determined. As illustrated in FIG. 8, starting from each unused Gap Line, the program walks around the room in the direction of the Gap Line, and tries to close the room by reaching that initial Gap Line. At every intersection in the SMS, the program always selects the left-most line for the next segment. This left-most “navigational method” will close the room unless there is a gap in one of the walls. When closing a room, any other Gap Line found is used as a normal wall line, but will be marked as a “Used Door” and will not try to close that same room later. FIG. 8 is a basic example of this process where the program moves from points 1-9 always making the left-most turn.

At step 445, door recesses are removed. This allows simplification of the resulting list of points. In FIG. 8, two wall segments touch a Gap Line (segment 2-3 and 9-1). If a segment is nearly perpendicular to the Gap Line and is shorter or equal to the WallThickness tolerance, it will be removed; this would remove the segment 9-1 and the point 1. Otherwise, it is left untouched at this step. This is illustrated at FIG. 9.

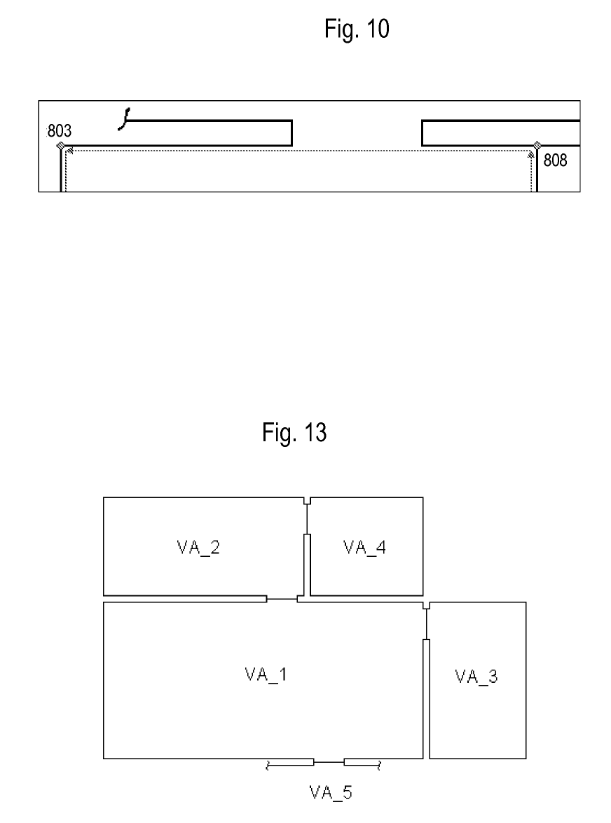

Next, a further simplification occurs at step 450 by removing collinear points. In the previous example shown in FIGS. 8 and 9, this would remove the points number 2 and 9, leaving only 3, 4, 5, 6, 7 and 8 as shown in FIG. 10.

In the final step before forming poly-lines, at step 455, if the resulting list of lines forming a VA Polyline contains lines linked to a CDO, that arc segment(s) is/are reconstructed. One looks recursively at neighboring segments to see if they fit the curve defined by the CDO. If they do they are included as part of the arc segment. This process eliminates all the stroke points created earlier.

Finally, at step 460, poly-lines are created. The system creates CAD Polyline Entities from the resulting list of line (and arc) segments. If an Error Point was encountered in the creation of a VA, that VA may be marked Yellow indicating the area has a high probability of having errors; if not it may be marked Green, indicating it has a high probability of having no errors.

Next, a user can repair any drawing errors in the poly-lines by comparing the Error Circles (on the Error Report Layer) to the original drawing elements and fix any drawing errors. The method of FIG. 4 can then be used again to create any missing virtual areas.

It should be recognized that these poly-lines may be used for any purpose, not only for use in conjunction with the system of FIG. 2.

FIGS. 11 and 12 illustrate the Parent-Child Relationships Finder component of the system of the present invention. This algorithm makes a comparative analysis between selected Poly-lines and Doors and then determines a Parent-Child relationship linking them.

FIG. 11 illustrates the set-up process for using the relationships finder component. Initially, at step 1110, Future VA Poly-lines must be located and specified by the user. VA Poly-lines may be located alone on a specified ‘VA Layer’, provided at step 410 in the previous process, or, if the method of FIG. 12 is to be used without the finder component, provided manually by the user in the drawing. Any other Polyline entities on this layer will be considered possible virtual areas, and might generate unwanted results.

Next, at step 1120, Door Layers & Door Blocks need to be located and specified by the user. The doors can be selected in two different ways: by their block names and/or by layers. To add to the selection, you can pick the entities or select the names from a list. The relationship component may now be invoked.

As shown in FIG. 12, at step 1210, all Poly-lines are retrieved and memory VA elements are created for them. Memory VA elements contain information about poly-lines, including items such as size, and relationships (such as whether the polyline is coupled to a door). The elements are used to find the relationship between the poly line and a door, or if, for example, two lines are connected to one door, then the relationship between the poly-lines.

Next, at step 1220, door lines are retrieved. All the Door Lines are all stored together in an SMS. A door find algorithm (described below) will find each isolated group of lines in that SMS and create a Door Element for each one of these Door Groups.

To find a Door Group, the algorithm starts with one line and gets all connected lines recursively until all the connected lines are gathered. Every time a line is gathered, it's marked as a UsedLine and cannot be part of another Door Group. This process is repeated for each Unused Line until each line is used.

Next, at step 1230, doors and virtual areas are linked. Now the connection between the Door Groups and the Poly-lines can be determined. Doors and VAs which are touching are marked. A door will be linked to 0, 1 or 2 VA(s). A VA will be linked to 0 to n doors.

Finally, the parent-child relationship is determined at step 1240. This occurs by using a “one Door Method”. An area with only one open door has access only through this door. Since this is the only access to this area, the connecting area (using this same door) becomes the parent in the relationship between the two areas by default.

This one-door determination is repeated until there are no further one-door areas. For example, in FIG. 13, five areas VA_{—}1 through VA_{—}5 are shown. The one-door method would close the door between VA_{—}2 and VA_{—}4, and assuming, the door between VA_{—}2 and VA_{—}4 is already closed, the next iteration of the algorithm would make VA_{—}2 and VA_{—}3 children of VA_{—}1 and close the two doors between them. At this point the parent-child relationship would look like this:
VA_{—}1
   VA_{—}2
      VA_{—}4
   VA_{—}3

Next, groups of areas are created. In the above example, if the newly created Parent VAs (in this case VA_{—}1), is now a One-Door VA (the door between VA_{—}1 and VA_{—}5), a new Group named Group_[Parent VA name] (in this case ‘Group_VA_{—}1) is created. The Parent VA is set as a child of the new group, and the first level children of the Parent VA are set as children of that new group. This flattens the Parent VA and its first level children, under the new group. All this done without loosing the parent-child links. The final result would look like this:
VA_{—}5
   Group_VA_{—}1
      VA_{—}1
      VA_{—}2
         VA_{—}4
      VA_{—}3

The two previous steps are repeated until all one-door VA and one-door VA Group are linked to their parents. The process outlined in FIG. 12 is a repetitive process, and may occur until all groups and areas are classified.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for marking a computer aided design drawing using a processing device, comprising:
finding a door gap in the drawing;
determining a room relative to said door gap; and
marking said drawing to indicate a room definition based on the step of determining.

2. The method of claim 1 wherein the step of finding a door gap comprises determining a set of gap points separated by a threshold wall thickness.

3. The method of claim 1 wherein the door is defined by at least three points, and the step of finding the door gap includes determining a gap line having a direction between at least two of the three points.

4. The method of claim 1 wherein the method further includes the step of retrieving wall lines in the drawing.

5. The method of claim 4 wherein the step of retrieving all wall lines in the drawing includes generating a temporary memory structure representing the wall lines comprising a collection of points and lines.

6. The method of claim 5 wherein the memory structure is destroyed following the marking step.

7. The method of claim 1 wherein the method further includes the step of retrieving all door lines in the drawing.

8. The method of claim 7 wherein the step of retrieving all door lines in the drawing includes generating a temporary memory structure representing the door lines comprising a collection of points and lines.

9. The method of claim 1 wherein the method further includes the step of finding at least one gap line.

10. The method of claim 9 wherein the step of determining a room comprises selecting wall lines beginning at a point in the gap line and following the direction of the gap line.

11. The method of claim 10 wherein the step of determining a room further comprises selecting the left-most line for a next segment until the gap line is reached.

12. The method of claim 9 wherein the step of finding at least one gap line includes the steps of:
selecting a first and a second group of contact points for a door gap;
determining edge points in each selected group; and marking a point at an edge of the first group and an edge point in the second group.

13. The method of claim 1 wherein the step of marking comprises:
creating CAD polyline entities in the drawing.

14. The method of claim 1 wherein the step of marking includes the further step of removing door recesses.

15. A method for automatically processing a computer aided design drawing using a processing device, comprising:
retrieving at least a set of door lines and a set of wall lines from the drawing;
creating a set of gap lines defining at least one door gap; and
determining a room area relative to each gap line.

16. The method of claim 15 wherein the process includes the further step of repairing gap lines having a tolerance less than a wall thickness tolerance specified by a user.

17. The method of claim 15 wherein the method further includes the step of determining a room area includes the step of removing collinear points.

18. The method of claim 15 further including the step of marking the drawing by creating CAD polyline entities.

19. The method of claim 15 wherein the method further includes the step of simplifying the set of wall lines and door lines into respective temporary data structures, each data structure comprising a collection of points an lines representing the door lines and wall lines, respectively.

20. The method of claim 15 further including the step, prior to the step of retrieving, of receiving user input on the location of wall lines in the drawing.

21. One or more processor readable storage devices having processor readable code embodied on said processor readable storage devices, said processor readable code for programming one or more processors to perform a method comprising the steps of:
finding a door gap in the drawing;
determining a room relative to said door; and
marking said drawing to indicate a room definition based on said step of determining.

22. One or more processor readable storage devices according to claim 21 wherein the step of marking includes the step of removing door recesses.

23. One or more processor readable storage devices according to claim 21 wherein the step of marking further includes the step of removing collinear points.

24. One or more processor readable storage devices according to claim 21 further including the step of reforming arc segments.

25. One or more processor readable storage devices according to claim 21 further including the step of creating CAD polyline entities for each of said room definitions.

26. One or more processor readable storage devices according to claim 21 further including the step of:
assigning a parent child hierarchy to each of said room definitions.

27. One or more processor readable storage devices according to claim 26 wherein the parent child hierarchy is determined based on access though a single door.

28. One or more processor readable storage devices having processor readable code embodied on said processor readable storage devices, said processor readable code for programming one or more processors to perform a method comprising the steps of:
creating at least one temporary data structure storing drawing information;
determining from the temporary data structure door gaps in the drawing;
successively determining walls of a room relative to the door gap; and
creating a room definition based on said step of successively determining.

29. A system for marking a drawing, comprising:
a processing device;
non-volatile memory coupled to the processing device instructing the processing device to perform the steps of:
finding at least one reference vector in the drawing;
determining an area definition based on drawing data relative to said reference; and
marking said drawing to indicate a area definition based on said step of determining.

30. A method for marking a computer aided design drawing using a processing device, comprising:
finding at least one reference vector in the drawing;
determining an area definition based on drawing data relative to said reference vector; and
marking said drawing to indicate an area definition.

31. The method of claim 30 wherein the step of finding a reference vector comprises defining a door gap.

32. The method of claim 30 wherein the step of determining an area definition comprises defining a virtual area definition.

33. The method of claim 30 wherein the drawing data relative to the reference is a wall line.

34. The method of claim 30 wherein the step of finding includes the step of creating at least one temporary memory structure representing the drawing data.

35. The method of claim 34 wherein the temporary memory structure includes a representation of the door or wall lines comprising a collection of points and lines.

36. The method of claim 30 wherein the step of marking comprises:
creating CAD polyline entities in said drawing data.

37. The method of claim 30, wherein the area definition corresponds to a virtual area, said step of marking said drawings includes:
automatically marking said drawing to indicate the area definition.
